(19) United States
(12) Patent Application Publication
(10) Pub. No.: US 2017/0363116 A1
(43) Pub. Date: Dec. 21, 2017

(54) Electro-hydraulic control terminal adopting modularized and configured cartridge valve RHCV

(71) Applicant: Shanghai Renhao Hydraulic Technology Co., Ltd, Shanghai (CN)

(72) Inventors: Renhao HUANG, Shanghai (CN); Canxing SUN, Shanghai (CN); Shenqi LOU, Shanghai (CN)

(73) Assignee: Shanghai Renhao Hydraulic Technology Co., Ltd

(21) Appl. No.: 15/606,137

(22) Filed: May 26, 2017

(30) Foreign Application Priority Data
May 31, 2016 (CN) 201610378926.3

(51) Int. Cl. F15B 13/08

(52) U.S. Cl. CPC F15B 13/0835; F15B 13/0814; F15B 13/0878

(57) ABSTRACT

The present invention aims at providing a new electro-hydraulic control terminal adopting modularized and configured cartridge valve RHCV. It has obvious advantages of hybrid combination and flexible customization when RHCV is applied in the independent control terminals based on “single loop resistance” to control hydraulic actuators including distributed cylinders and motors. It can follow the rules that functional diversities as many as possible can be achieved through technical diversities as few as possible, thus producing a new generation of electro-hydraulic product family and platform to meet the needs of customers.

### TECHNICAL FIELD

The present invention relates to electro-hydraulic control technology, especially applications of new electro-hydraulic control terminals based on cartridge valve technology and mounting holes for connection.

### BACKGROUND

At present, in the field of control technology of electro-hydraulic drive, people focus on: aiming at efficiency, intelligence and high quality, to create and own international competitiveness is a new strategy. In China, innovation characteristic of flexibility and variability can meet users' requirements for a new generation of electro-hydraulic control products and solutions with independent intellectual property rights, thus fundamentally getting rid of excessive dependence on foreign technology and realizing sustainable development.

The most typical hydraulic drive technology and huge number of applications focus on double-acting cylinder with single rod and oil motor with reversible cavities and circuit devices. Due to cylinders and motors are often one of the host service equipments supplied for final customer, they often present as one kind of hydraulic terminals of machinery in accordance with the meaning of “terminal”. Hydraulic control circuit equipments to control the input and output cavities of cylinders and motors have shown its essence as the electro-hydraulic control terminal and trend for further combination with actuators.

Terminals of current cylinders and motors use commercially available solution of four way circuit comprised by four or multilateral edges in the product family, which is based on mounting surface and sectional connection and is the mainstream of the market application and quantity. Quadrilateral combination scheme has disadvantage caused by historical formation, whose unilateral controllability is contradicted with new demand of technology development. And a single product family of traditional form of components and the design and combination design of four way circuit also have redundant factors, which is difficult to meet the current requirements for high efficiency, intelligence, high quality and sustainability. At the same time, due to discreteness of technical scheme, control products and devices have poor manufacurability leading to scattered supply chain and inefficiency, etc., thus influencing the scheme rationality and sustainability.

Later in the same period, two kinds of cartridge product based on mounting holes rapidly become independent technical scheme characteristic of “single control resistance” with new product structure and connection features. Modularized and configured cartridge valves RHCV based on MINISO CV has theoretical support and guidance from “fluid resistance theory”. First, in terms of principle of “single control resistance”, the traditional model that is based on single component to combine a single component loop system is transformed to the model that is based on a single resistance to combine a single resistance loop system; in terms of product portfolio as a whole, the work of “three elimination” is undergone, that is the elimination of single component's valve body, mounting surface and its corresponding manifolds. High precision molded “body” of single component, mounting surface, and valve body only for oil ports can be getting rid of. At the same time, it can extremely obviously make the overall structure compact, lightweight, miniaturization and rationalization, and optimize the supply chain greatly, thus profoundly overturns the traditional model of technical scheme of fluid drive and control circuit and system and supply chain. So critical support and new space are provided for implementation of RHCV in a larger range of applications to create a more systematic and comprehensive independent compact electro-hydraulic solution. Therefore, patent person entitle them: a new electro-hydraulic control terminal adopting modularized and configured cartridge valve RHCV.

Because RHCV is MINISO CV's further innovation, the proposed new modularized and configured cartridge valve RHCV focus on the [standardization] [ modularization] and [decomposability], and [similarity] [compatibility] in the product line. The development is oriented to serialization of products and innovation and restructuring of mechanic-electro products. There will be reform from the method of product formation to supply chain as a whole in terms of electro-hydraulic control products. We shall focus on the new electro-hydraulic control terminals directly or nearly installed on all kinds of cylinders and motors to meet the complicated requirements for individuation and diversification. Besides, by way of the transformation and upgrading of the current product family, excessive dependence on foreign technology and the status quo of the low end of products will be get rid of.

### BRIEF SUMMARY OF THE INVENTION

When adopting modularized and configured cartridge valve RHCV as “single control resistance” in the new electro-hydraulic control terminal, (RHCV) can give full play to its peculiar internal structure characteristic of two different mounting holes of cartridge and compatible main stage of poppet valve. So you can adopt hybrid combination of main stages and pilot control ports which are totally different from the traditional configuration and are obvious diverse and flexible. Seemingly complicated main and pilot stage of cartridge valves will become simple and easy to grasp, which is in accord with efficiency, high quality and intelligence. So mechanic-electro integrated compact electro-hydraulic control terminals and its variants are easily designed with the help of intelligence and computer. Specific invention content is as follows:

The new electro-hydraulic control terminal adopting a new kind of modularized and configured cartridge valve RHCV, comprising:

two modularized and configured screw-in cartridge valves;
two compact two-way cartridge valves;
integrated functional valve body;
hybrid pilot control ports of self-supplied oil;
accessories for connection, detection and communication;
wherein two modularized and configured screw-in cartridge valves are used as oil-input resistance characteristic of different structures and combinational types in the basic four-way loop, within the valve body they have two different arrangements, one lies in the situation that two screw-in cartridge valves are on the same side of the same face, the other lies in that two screw-in cartridge valves are on the opposite side of the opposite face;
wherein two compact two-way cartridge valves are used as oil-output resistance characteristic of different structures and combinational types in the basic four-way loop, within the valve body they have one arrangement that two compact two-way cartridge valves are on the same side of the same face, at least one compact two-way cartridge valve is necessary in the basic four-way loop;
wherein integrated functional valve body has two forms L and H according to different characteristics of internal mounting holes and layout of pilot control holes, form L is used when two modularized and configured screw-in cartridge valves are arranged on the same side of the same face, form H is used when two modularized and configured screw-in cartridge valves are arranged on the opposite side of the opposite face; wherein hybrid pilot control ports of self-supplied oil are characteristic by that self-supplied oil Pc is imported by the control port X on the cover plate of compact two-way cartridge valve, pilot control oil is connected with oil-output port Tc through the control port Y, self-supplied oil Pc enters in the control cavity of compact two-way cartridge valve through control port a on the combinational flange control cover plates; through control port Z1 and Z2, control port S3 of modularized and configured screw-in cartridge valve is connected vertically, thus individually or combinational controlling the four main stage of poppet valve within the valve body; wherein accessories for connection, detection and communication can be configured according to the demands of four-way loop;
wherein through the hybrid control resistances comprising modularized and configured screw-in cartridge valves and compact two-way cartridge valves, two reversible cavities of controllable hydraulic actuators can be controlled, combining into independent and integrated electro-hydraulic control terminal LEM and HEM with different shapes, however they have same supply chain characteristic with four controllable main ports P, T, A, B and multiple auxiliary ports.

Integrated functional valve body with L shape consists of two mounting holes of modularized and configured screw-in cartridge valves, two mounting holes of compact two-way cartridge valves, hybrid, pilot control ports of self-supplied oil, mounting holes and connection interface for connection, detection and communication; wherein two mounting holes of modularized and configured screw-in cartridge valves are arranged on the same side of the same face; wherein two mounting holes of compact two-way cartridge valves are arranged on the same side of the same face, at least one compact two-way cartridge valve is necessary in the basic four-way loop; wherein accessories for connection, detection and communication can be configured according to the demands of four-way loop; wherein two mounting holes of modularized and configured screw-in cartridge valves and two mounting holes of compact two-way cartridge valves are arranged on the adjacent face, they together with hybrid pilot control ports of self-supplied oil and mounting holes and connection interface for connection, detection and communication combine into integrated functional valve body BL characteristic of regular hexahedral shape with four controllable main ports P, T, A, B and multiple auxiliary ports.

Integrated functional valve body with H shape consists of two mounting holes of modularized and configured screw-in cartridge valves, two mounting holes of compact two-way cartridge valves, hybrid pilot control ports of self-supplied oil, mounting holes and connection interface for connection, detection and communication; wherein two mounting holes of modularized and configured screw-in cartridge valves are arranged on the opposite side of the opposite face; wherein two mounting holes of compact two-way cartridge valves are arranged on the same side of the same face, at least one compact two-way cartridge valve is necessary in the basic four-way loop; wherein accessories for connection, detection and communication can be configured according to the demands of four-way loop; wherein two mounting holes of modularized and configured screw-in cartridge valves and two mounting holes of compact two-way cartridge valves are arranged on the adjacent face, they together with hybrid pilot control ports of self-supplied oil and mounting holes and connection interface for connection, detection and communication combine into integrated functional valve body BH characteristic of regular hexahedral shape with four controllable main ports P, T, A, B and multiple auxiliary ports.

There are hybrid pilot control ports of self-supplied oil; self-supplied oil. Pc after being compared and chosen within the valve body is imported by the control port X on the cover plate of compact two-way cartridge valve, pilot control oil is connected with of -output port Tc through the control port Y, self-supplied oil Pc enters in the control cavity of compact two-way cartridge valve through control port a on the combinational flange control cover plates; through control port Z1 and Z2, control port S3 of modularized and configured screw-in cartridge valve arranged on the same side of the same face or on the opposite side of the opposite face is connected vertically, combinational flange control cover plates as the main carrier for pilot control comprehensively control compact two-way cartridge valves and modularized and configured screw-in cartridge valves, having the connecting feature of “one carrier controls more than one assembly”.

The margin design is adopted in layout of overall design and main structure, including the first mounting face of main function, the second mounting face of main function, and mounting face of non-main function; wherein the first mounting face of main function refers to the face with compact two-way cartridge valves' two mounting holes and the mounting faces of flange control cover plates; wherein the second mounting face of main function refers to the face with two modularized and configured screw-in cartridge valves' mounting holes; wherein mounting face of non-main function refers to the face for other non-main functional artifacts; when the combinations, functions, specifications, quantity, and local circuit scheme belonging to the main stage of poppet valve and mounting holes of two-way cartridge valves on the first mounting face of main function change, even when the pilot control components and the corresponding pilot control ports change, it can make sure that existing margin of basic integrated functional valve body can be made use of. The first and second mounting face not only influence the layout of mounting face of main functional components and its connection features, but also influence the margin design of layout of different installation and connection; mounting face of non-main function influence the layout of different installation and connection;

Valve body is connected, fixed and sealed with the input and output of controllable actuator such as hydraulic cylinder throughout circumferential flange, combining into main body of electro-hydraulic control terminals and basic type of valve body which can be installed directly on the double-acting hydraulic actuator; wherein port A or B of valve body installed directly is separately matched with the port A or port B of hydraulic controllable actuator, thus directly connecting the main valve body with the corresponding ports of controllable actuator. The other port of basic valve body indirectly matched with the hydraulic actuator is connected with the hydraulic actuator through fittings and tubes. Port P and T of the basic valve body are connected with the oil supplier P and T through fittings and tubes.

The mounting face at the bottom of the valve body has two or more ports of P, A, B, T; wherein the types of mounting face include one kind of mounting face conforming to Standard ISO4401; wherein the compact electro-hydraulic control terminals adopting Standard ISO4401 are alternatives of single hydraulic manifolds and sandwich integrated circuit bodies conforming to same Standard ISO4401; wherein the compact electro-hydraulic control terminals adopting Standard ISO4401 can also be installed on or near the input and output of controllable actuators such as hydraulic cylinders and motors.

Valve body group consists of two valve bodies; wherein valve body for installation at the bottom of valve body group uses the type of mounting face conforming to Standard ISO4401, and four main ports P, A, B, T are arranged on the mounting face of electro-hydraulic control terminals; wherein the compact electro-hydraulic control terminals adopting Standard ISO4401 are alternatives of single hydraulic manifolds and sandwich integrated circuit bodies conforming to same Standard ISO4401; wherein the compact electro-hydraulic control terminals adopting Standard ISO4401 can also be installed on or near the input and output of controllable actuators such as hydraulic cylinders and motors.

Valve body is connected and fixed with the controllable actuators including power units, hydraulic cylinders and motors; wherein four main ports P, A, B, T set on the valve body are connected with the input and output ports of the controllable actuators including power units, hydraulic cylinders and motors through fittings and tubes directly; wherein the screw holes are pre-set on the valve body for installation.

Among the hybrid combination of two sets of modularized and configured screw-in cartridge valve and compact two-way cartridge valve, modularized and configured screw-in cartridge valve will he prioritized; after variant design regarding basic valve body, other commercial screw-in cartridge valve conforming to Standard ISO7789 can be made use of, thus constituting a kind of valve body with asymmetrical layout of mounting holes, which consists of two mounting hales of compact two-way cartridge valve, a mounting hole of modularized and to configured screw-in cartridge valve and a mounting hole of screw-in cartridge valve conforming to other types.

Among the hybrid combination of two sets of modularized and configured screw-in cartridge valve and compact two-way cartridge valve, one screw-in cartridge valve is replaced by one compact two-way cartridge valve with LVDT displacement-electric feedback through which electro-hydraulic proportional flow adjustment can be realized; after variant design regarding basic valve body, it constitutes a kind of valve body with asymmetrical layout of mounting holes, which consists of three mounting holes of compact two-way cartridge valve and a mounting hole of modularized and configured screw-in cartridge valve.

Among the hybrid combination of two sets of modularized and configured screw-in cartridge valve and compact two-way cartridge valve, one screw-in cartridge valve having the function of pressure compensation is added, thus constituting the electro-hydraulic control terminals having the function of pressure compensation; one mounting hole for the screw-in cartridge valve having the function of pressure compensation is added in the corresponding valve body, thus constituting a kind of valve body with asymmetrical layout of mounting holes, which consists of two mounting holes of compact two-way cartridge valve and three mounting holes of modularized and configured screw-in cartridge valve.

The electro-hydraulic control terminal that has the 3/4 loop function, consists of one compact two-way cartridge valve with 3 position pilot solenoid valve and three modularized and configured screw-in cartridge valves; wherein integrated functional valve body is arranged with asymmetrical layout of mounting holes and consists of one mounting hole of compact two-way cartridge valve and three mounting holes of modularized and configured screw-in cartridge valve.

Self-supplied oil is replaced by external-supplied oil, thus constituting a kind of electro-hydraulic control terminal whose oil is supplied externally.

According to decomposition design and combination principle regarding the hydraulic circuit of two-way cartridge valve, it has decomposability; two cavities are controlled by one three-way hydraulic loop which consists of two cartridges with different structures and combination features and is a fundamental and independent solution to cavity of electro-hydraulic control terminals; electro-hydraulic control terminal conforming to three-way hydraulic loop is flexible to meet all kinds of functions and form structures, thus controlling the two cavities of double-acting controllable hydraulic actuator separately; wherein electro-hydraulic control terminal conforming to three-way hydraulic loop can be used to control one cavity of single-acting controllable hydraulic actuator, constituting the electro-hydraulic control terminal to control single-acting controllable hydraulic actuator with one cavity; wherein the basic type of to integrated functional valve body conforming to three-way hydraulic loop consists of ones mounting hole of compact two-way cartridge valve and one mounting hole of modularized and configured screw-in cartridge valve, this kind of hybrid combination solution including electro-hydraulic control terminal with externally supplied pilot oil has the feature of variant adaptability.

The new electro-hydraulic control terminal adopting a new kind of modularized and configured cartridge valve RHCV, comprising:

two modularized and configured screw-in cartridge valves;
two compact two-way cartridge valves;
integrated functional valve body;
hybrid pilot control ports of self-supplied oil;
accessories for connection, detection and communication;
wherein two modularized and configured screw-in cartridge valves have same size;
wherein two compact two-way cartridge valves have different size to meet different needs of rod cavity and piston cavity of asymmetric double-acting cylinder with one rod; wherein integrated functional valve body has asymmetric layout amounting, holes; wherein the electro-hydraulic control terminal characteristic of mechanical-electro integrated connection for installation and supply chain has four controllable main ports, P, A ,B, T and multiple auxiliary ports.

### ADVANTAGEOUS EFFECTS

1. The present invention proposes the new independently electro-hydraulic control terminals' basic type and part of the variant type which can be directly or nearly installed on all kinds of cylinders and motors. The basic types are LEM and HEM. The variant types are based on LEM and HEM and undergoing some local variation. These independent solutions are applied in distributed oil cylinders and motors. They have obvious technical superiority of hybrid combinations, and flexible customization adaptability.

2. At the same time, hybrid “single resistance loop” combination scheme and the new circuit principle diagram based on RHCV in terms of independent compact electro-hydraulic control terminal characteristic of mechanic-electrical integration are put forward. New circuit principle diagram is on the basis of “fluid resistance theory”, “hydraulic circuit design and combination of decomposition type” of “single resistance”, “the principle of minimum fluid resistance”, “characteristics of controlled chamber”. The modular, configured and open-design display is adopted. And through separately complicated and simple ways, technological scheme and circuit principle of the new electro-hydraulic control terminal adopting a new kind to of modularized and configured cartridge valve RHCV is exactly expressed with vivid image.

3. According to “decomposable principle” and “the principle of minimum fluid resistance” in the “hydraulic circuit design and combination of decomposition is type”, we further put forward simplified form, combination scheme and circuit principle of three-way “loop of single resistance” through segmentation and processing of four-way new circuit principle diagram of “loop of single resistance” and electro-hydraulic control terminal. The basic type of three-way electro-hydraulic control terminal is formed in accordance with three-way “loop of single resistance”, which can be applied in a controllable cavity in distributed oil cylinder of single acting type, or one controlled cavity of two chambers in distributed oil cylinder.

4. We put forward valve body of both basic type and part of variant type belonging to compact electro-hydraulic control terminal characteristic of mechanic-electro integration which can be directly or nearly installed in the controllable cylinders and motors. The basic type is BL and BH belonging to LEM and HEM separately. The combination of mounting holes of main stage and pilot control ports obviously have hybrid feature, main oil port P, T, A, B, multiple pilot ports and auxiliary ports can be directly distributed in the each side of hexahedron. And it has the following characteristics and technical advantages:
1. Due to the proposed four-way new circuit principle diagram of “loop of single resistance” and the derived circuit principle of three-way “loop of single resistance” according to “decomposable principle”, there will be reform about the equipments as a whole which are dominant in the market and based on the “single component” and function as “single component loop”.
1.1 In terms of design and combination of the circuit, the guidance based on the “single component” is transformed to that based on the “single resistance” under the guidance of “fluid resistance theory”.
1.2 The design characteristic of slightly big valve body and traditionally discrete structure can be transformed into functional basic modular based on “single resistance loop” which is mainly dominated by mounting holes as power level units.
1.3 Integrated valve manifolds characteristic of slightly big valve body and traditionally discrete structure based on “single component loop” can be transformed into compact, lightweight and miniaturized electro-hydraulic control terminals based on “fluid resistance theory” which is mainly dominated by tinting holes as power level units.

Choosing “component” is replaced by single “resistance” not only relates to the change of principle scheme, but also involves the change of the functional structure and connection. The work of “three elimination” is undergoing, that is the elimination of single component's valve body, mounting surface and its corresponding manifolds, thus eliminate and reduce the redundancy because of historical reason. And this is the key and foundation to create compact, lightweight and miniaturized electro-hydraulic control terminals.

1. At the same time, because of “three elimination”, highly precise “casting” blank which can hear high pressure can be eliminated and reduced as much as possible. We can mainly give priority to commercial available material, which is easily processed and beneficial for the implementation of supply chain management characteristic of high efficiency, low consumption and intelligent manufacturing. The proposed product family and platform completely change the traditional integrated manifolds, system and its existing mode of supply chain based on “single component loop”. And new mode of supply chain is formed.

2. Through separately complicated and simple ways, hybrid advantages and flexible customization of the new electro-hydraulic control terminal adopting a new kind of modularized and configured cartridge valve RHCV based on the principle scheme of three-way and four-way “single resistance loop” is exactly expressed with vivid image. It is beneficial for the implementation of supply chain management and lay foundation for the design management of intelligence and computer design.

3. The new independently electro-hydraulic control terminals' basic type and part of the variant type which can be directly car nearly installed on all kinds of cylinders and motors can provide a new kind of product family and platform. This innovation can completely change the existing mode of supply chain based on the “single component circuit and system” and form a new supply chain. Besides, it can redefine the market of hydraulic market and put forward a new strategy, thus creating a new market trend and subdivision technology.

4. We put forward valve body of basic type, detailed mounting holes of main stage of poppet valve and hybrid combination of pilot channels and detailed features including combined flange cover plates and hybrid combination of screw adaptors, which totally belong to compact electro-hydraulic control terminal LEM and HEM characteristic of mechanic-electro integration which can be directly or nearly installed in the controllable cylinders and motors.

5. Compact electro-hydraulic control terminal LEM and HEM which can be directly installed in the controllable cylinders and motors especially reflect the trend of integration between controllable double-acting cylinder and motors. It is advantageous to the transformation and upgrading of existing hydraulic control technology in China. Because they are new product family and platform boosted by RHCV technology application, it will relates to the transformation and upgrade of new business mode, even leading to transformation of supply and marketing integration of the new generation product line.

6. In accordance with many theories and application practice including “fluid resistance theory”, “single resistance”, “hydraulic circuit design and combination of decomposition type”, “minimum resistance”, “featured controlled cavity”, the principle scheme based on the three-way “single resistance loop” and basic type of electro-hydraulic control terminals are proposed. This basic type and that of four-way type are mutually compatible and based on the common principle scheme and connection type. Functional diversities as many as possible can be achieved through technical diversities as few as possible.

### BRIEF DESCRIPTION OF THE DRAWINGS

EM-electro-hydraulic control terminals

FIG. 1A 3D explosion figure of LEM

FIG. 1B 3D assembly figure of LEM

FIG. 1C 3D explosion figure of HEM

FIG. 3D 3D assembly figure of HEM new principle scheme of circuit (typical 4/4 “single resistance loop”)

FIG. 2A complicated 4/4 single resistance loop (LEM) (4/4 directional and differential control)

FIG. 2B simplified 4/4 single resistance loop (LEM) (4/4 directional and differential control)

FIG. 2C single component loop for comparison (3/4 directional and differential control)

FIG. 2D new symbolic scheme of position (a typical 4/4 “single resistance loop”)

FIG. 2E complicated 4/4 single resistance loop (LEM) (4/4 directional grid AB cavity with limited pressure)

FIG. 2F simple 4/4 single resistance loop EM (4/4 directional and AB cavity with limited pressure)

FIG. 2G single component loop for comparison (3/4 directional and AB cavity with limited pressure)

FIG. 2H new symbolic scheme of position (a typical 4/4 “single resistance loop”)

3D figure of integrated functional valve body and layout feature of inner mounting holes:

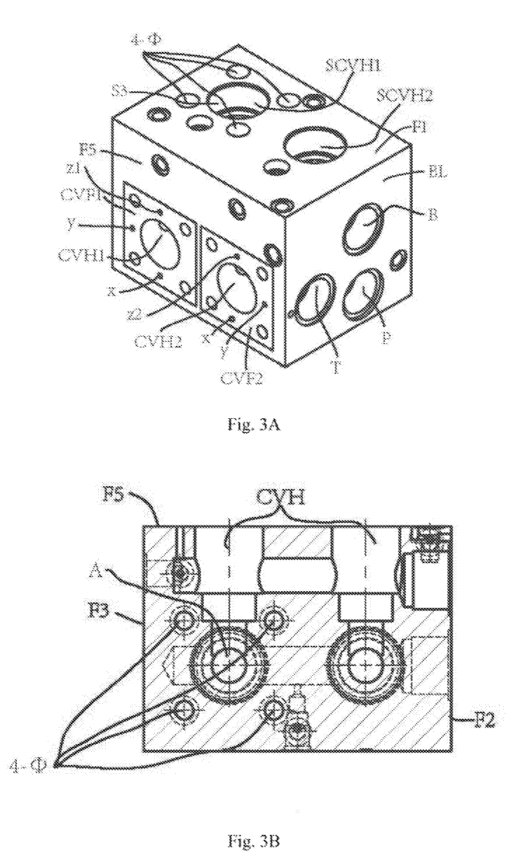

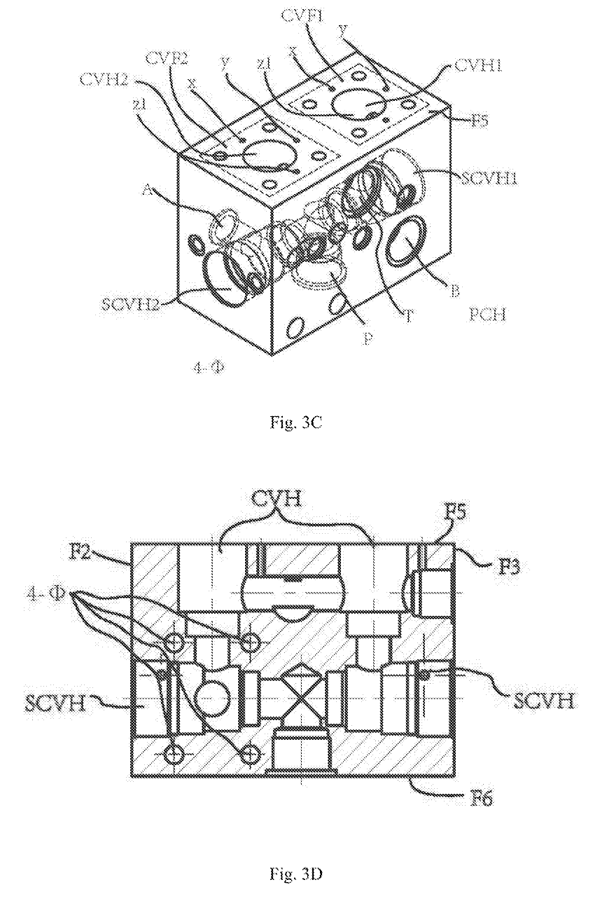

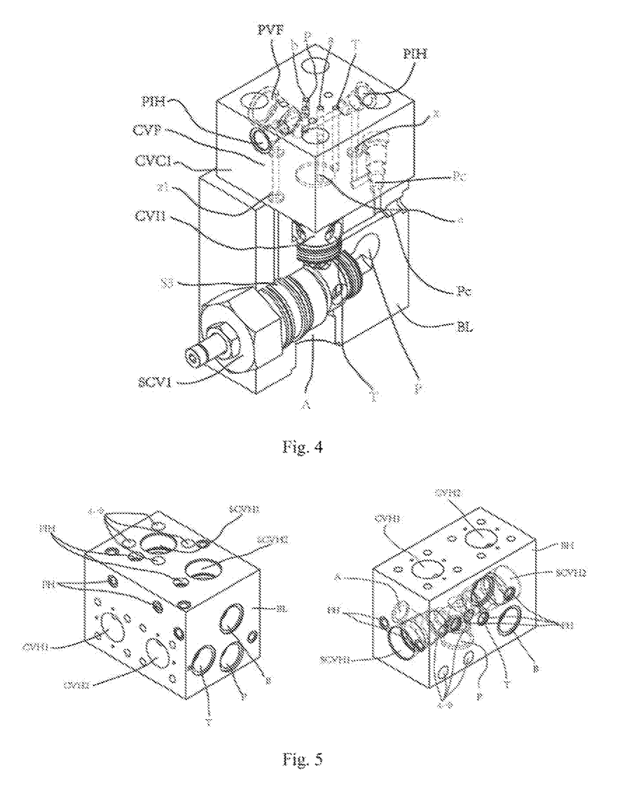

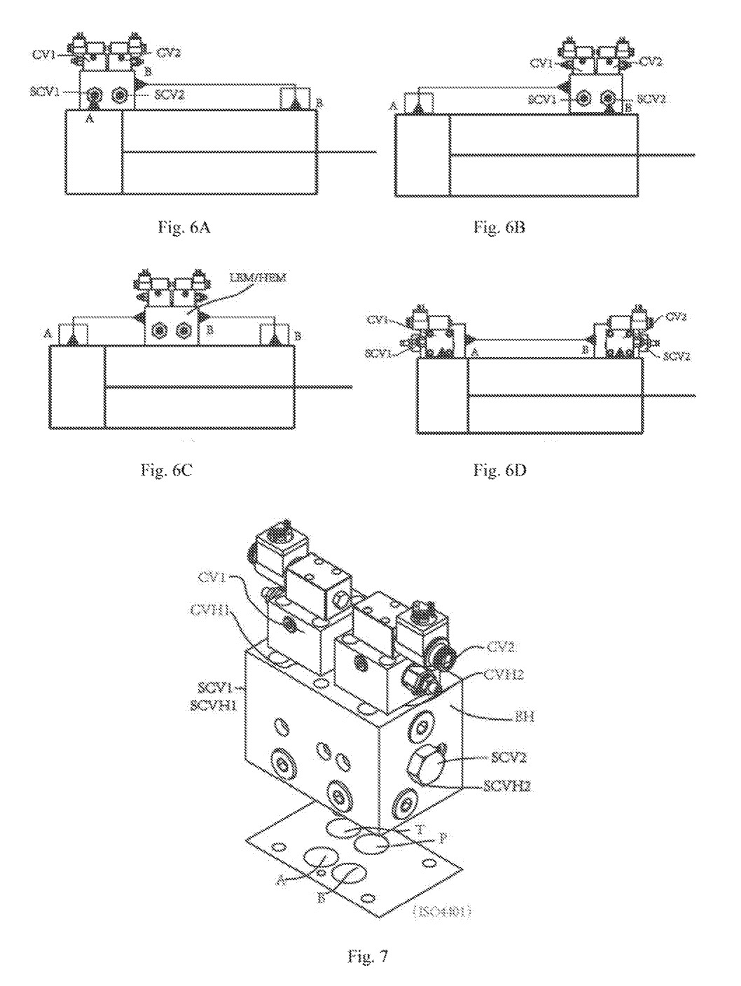

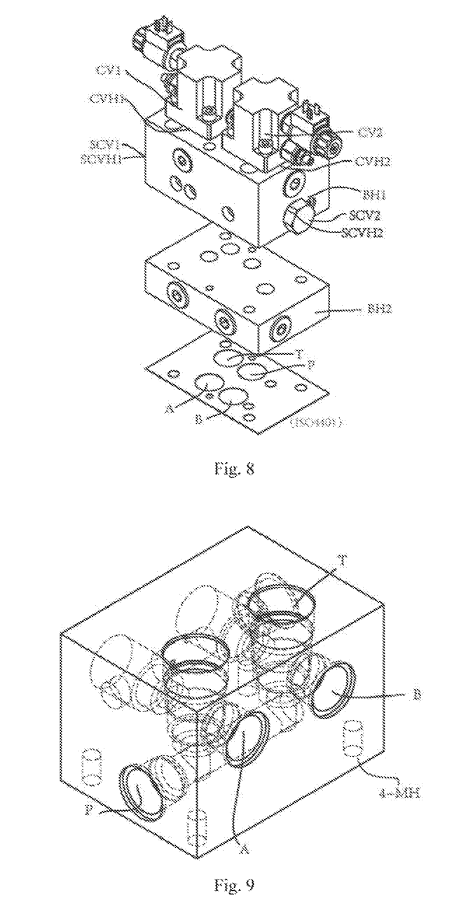

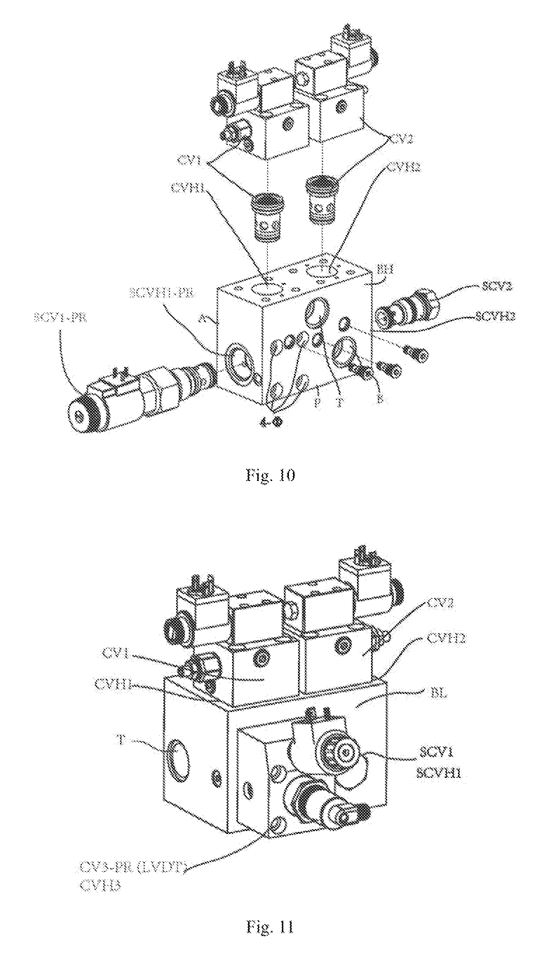

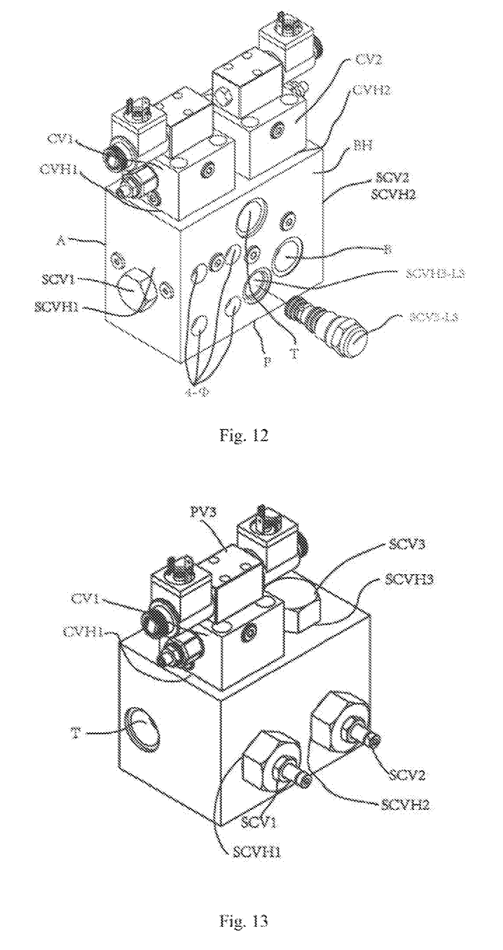

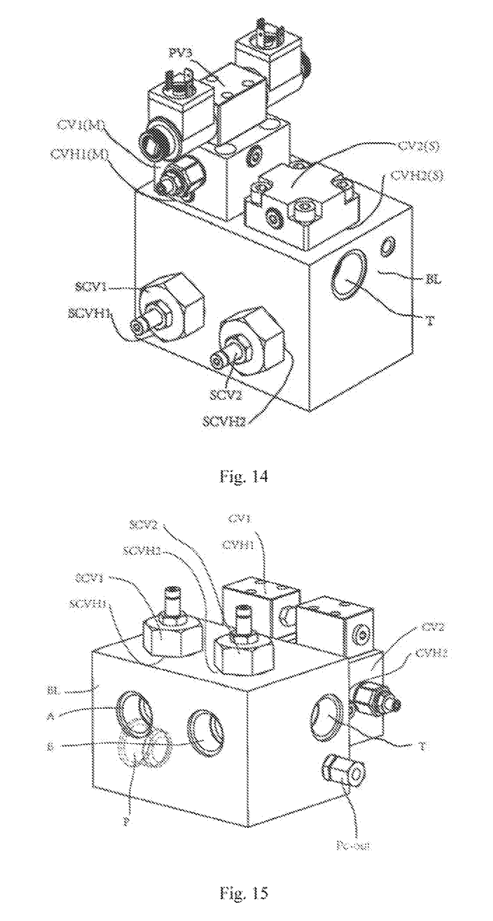

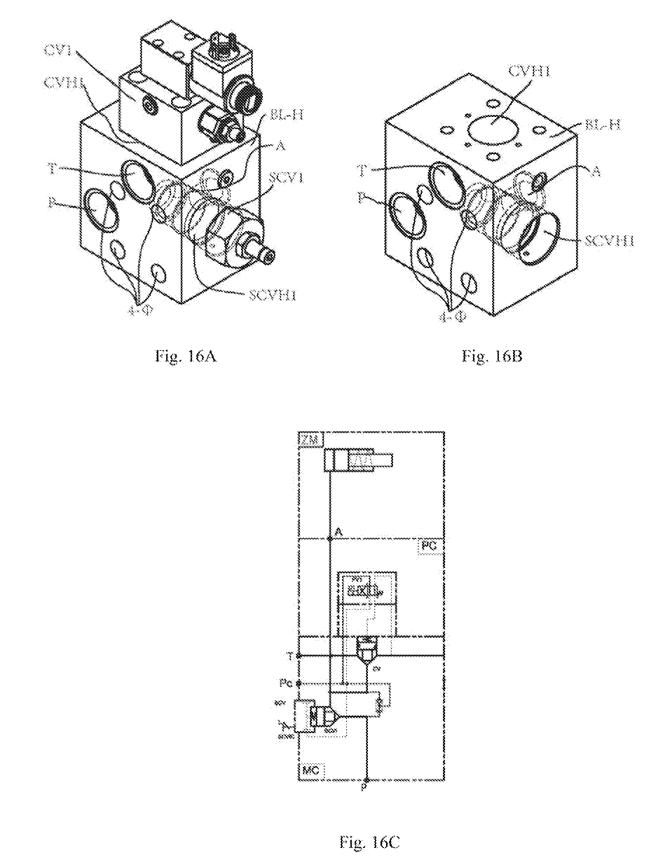

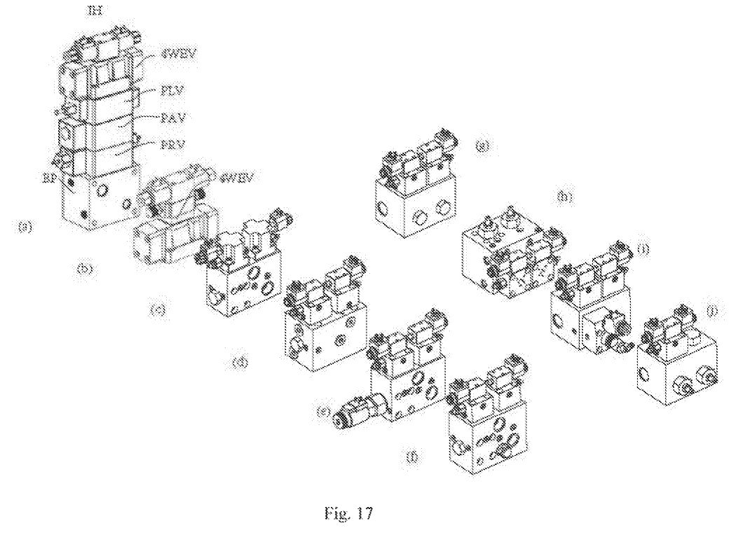

FIG. 3A 3D figure of integrated functional valve body BL

FIG. 3B integrated functional valve body BL and layout feature of inner mounting holes

FIG. 3C 3D figure of integrated functional valve body BH

FIG. 3D integrated functional valve body BE and layout feature of inner mounting holes

FIG. 4 hybrid layout of cartridge boles of LEM electro-hydraulic control terminals' integrated functional valve body and pilot control ports characteristic of “one carrier controls more than one assembly”

FIG. 5 symmetrical integrated functional valve body BL and BH of basic type including variant design and margin of direct connection schematic diagram of direct or near connection between electro-hydraulic control terminals and. input/output port of cylinder is as follows:

FIG. 6A schematic diagram of direct or near connection between electro-hydraulic control terminals and piston cavity of cylinder

FIG. 6B schematic diagram of direct or near connection between electro-hydraulic control terminals and rod cavity of cylinder

FIG. 6C schematic diagram of respective connection between electro-hydraulic control terminals and piston/rod cavity of cylinder

FIG. 6D schematic diagram of direct or near respective connection between electro-hydraulic control terminals and piston/rod cavity of cylinder

FIG. 7 HEM electro-hydraulic control terminal and its integrated functional valve body with mounting face complying with ISO4401

FIG. 8 HEM electro-hydraulic control terminal with mounting face complying with ISO4401 (consists of two valve bodies)

FIG. 9 a kind of valve body with interface for power units and cylinders

FIG. 10 an asymmetric valve body with mounting holes complying with ISO7789 and other standards (left drawing is proportional flow valve with displacement-mechanical feedback and its mounting hole)

FIG. 11 an asymmetric valve body with proportional flow valve with displacement-electrical feedback

FIG. 12 an asymmetric valve body with screw-in cartridge valve with pressure compensation

FIG. 13 electro-hydraulic control terminal consisting of compact two-ways cartridge valve with 3 position solenoid valve and three modular and configured screw-in cartridge valve and its asymmetric valve body

FIG. 14 HEM-Z electro-hydraulic control terminal configured in accordance with different input and. output displacement of single-rod cylinder and its asymmetric valve body

FIG. 15 HEM-OP electro-hydraulic control terminal (variant type) with externally supplied pilot oil

HEM-H electro-hydraulic control terminal based on “three-way circuit” and valve body is as follows:

FIG. 16A HEM-H electro-hydraulic control terminal based on “three-way circuit” (variant type)

FIG. 16B HEM-H valve body based on “three-way circuit” (variant type)

FIG. 16C “three-way resistance circuit” of HEM-H electro-hydraulic control terminal based on “three-way circuit” (variant type)

FIG. 17 comprehensive comparison between HEM-LEM electro-hydraulic control terminal and IH/4WEV (form 1:1)

### MARK OF DRAWING

Z double-acting controllable cylinder
ZM single-acting controllable cylinder
M single-acting controllable motor
EM electro-hydraulic control terminal
LEM electro-hydraulic control terminal of form L with BL integrated functional valve body;
HEM electro-hydraulic control terminal of form H with BH integrated functional valve body;
HEM-H electro-hydraulic control. terminal based on “three-way circuit”
B integrated functional valve body
BL functional valve body of with L mounting hole for main stage
BL-1 valve body of basic type
BL-H valve body based on “three-way circuit”
BH functional valve body of with H mounting hole for main stage
BH-1 functional valve body of basic type
F face, mounting face
F1-6 six faces of hexahedral integrated functional valve body F1,F2,F3,F4,F5,F6)
CVF mounting face of MINISO CV combined flange cover plate
(x, y, z, z) control port of MINISO CV combined flange cover plate
PVF pilot mounting face PV
H mounting holes
CVH mounting hole of MINISO CV compact two-way cartridge valve
CVH(M/S) mounting hole of compact two-way cartridge valve of size (M/S)
SCVH mounting hole of MINISO CV modularized and configured screw-in cartridge valve
SCVH-ISO mounting hole of screw-in cartridge valve complying with ISO-7789 or other standards
SCVH-LS mounting hole of screw-in cartridge valve with pressure compensation
SCVH-PR mounting hole of proportional throttling valve with displacement-mechanical feedback
S3 MINISO-SCV control ports (prioritized pilot control ports)
PIH mounting hole of pilot valve
PH mounting hole of plugs
P ports
P, T, A, B main oil port
C, TC control oil port
MC measuring oil port
Pc-out external oil input port
4˜Φ connecting hole of direct installing flange
4˜MH mounting screw hole
CV (MINISO CV) Compact Two-Way Cartridge Valve
ISO CV commercial two-way cartridge valve complying with ISO7368
CV(M/S) compact two-way cartridge valve of size (M/S)
CV-PR compact two-way cartridge valve with LVDT
CV1 main stage of poppet valve, cartridge
CVIC intermediate connector
CVC combined flange cover plates
CVCB combined flange cover plate body
CVF mounting face of compact two-way cartridge valve (MINISO CV)
SCV modularized and configured screw-in cartridge valve (MINISO SCV)
SCV1 main stage of poppet valve
SCV1C screw adaptor
V pilot/v (Abbreviation), pilot control valve
PV pilot solenoid directional valve of plate connection
SV solenoid directional valve of screw connection
RV pilot pressure valve of screw connection
AC pilot check valve of screw connection
PL combined plug
SCV-PR proportional throttling valve with displacement-mechanical feedback
SCV-LS screw-in cartridge valve with pressure compensation
4WEV a 3/4 solenoid directional valve
PLV a sandwich throttling valve
PAV a sandwich check valve
PPV a sandwich relief valve
IH sandwich circuit manifolds

### DETAILED DESCRIPTION OF PREFERRED EMBODIMENTS

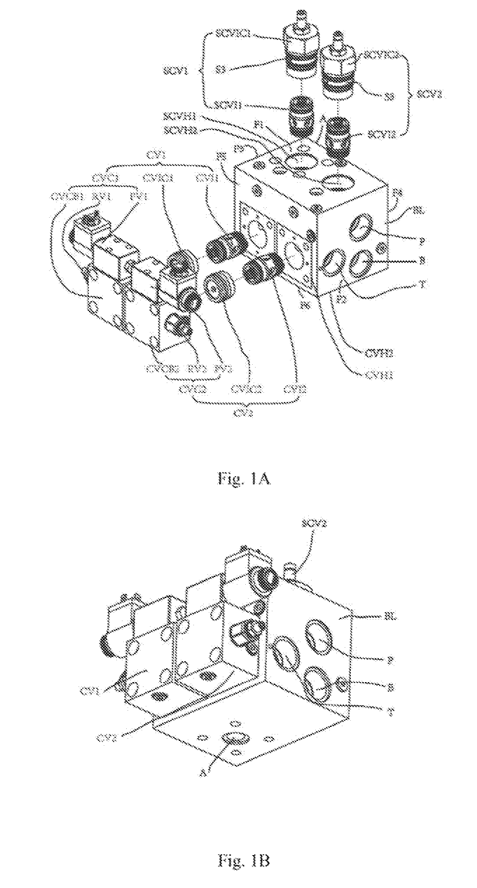

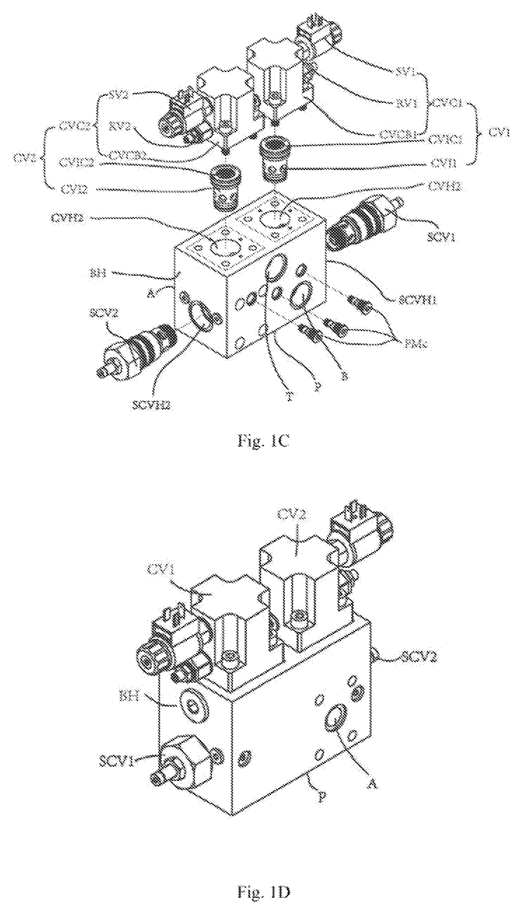

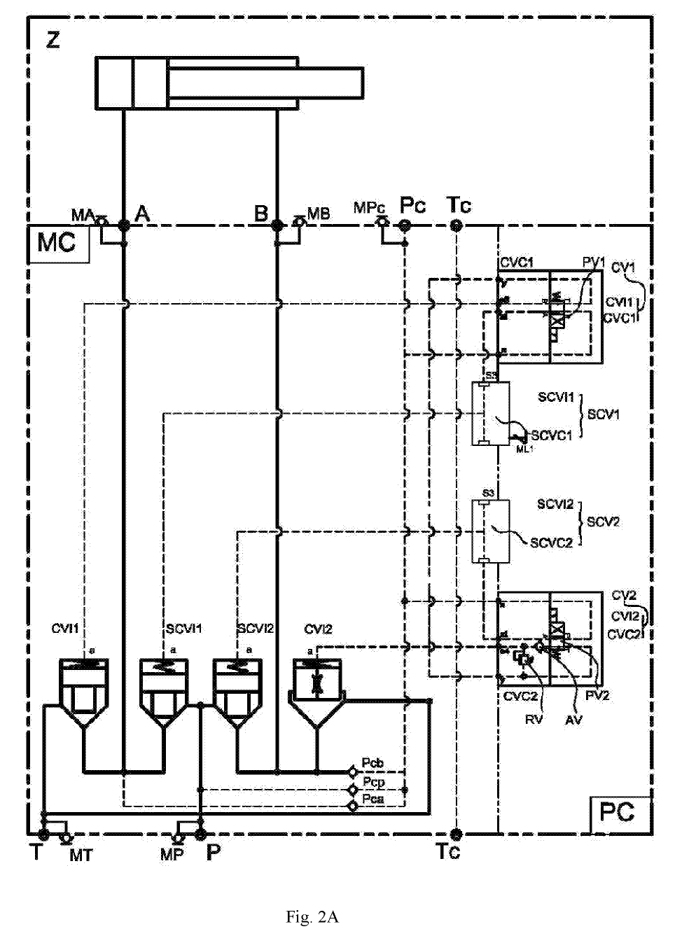

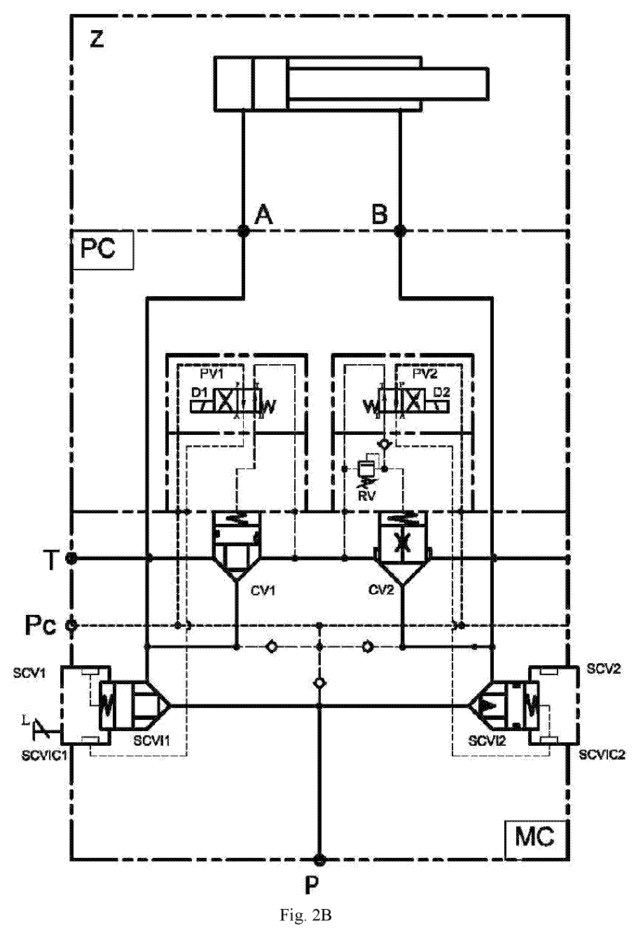

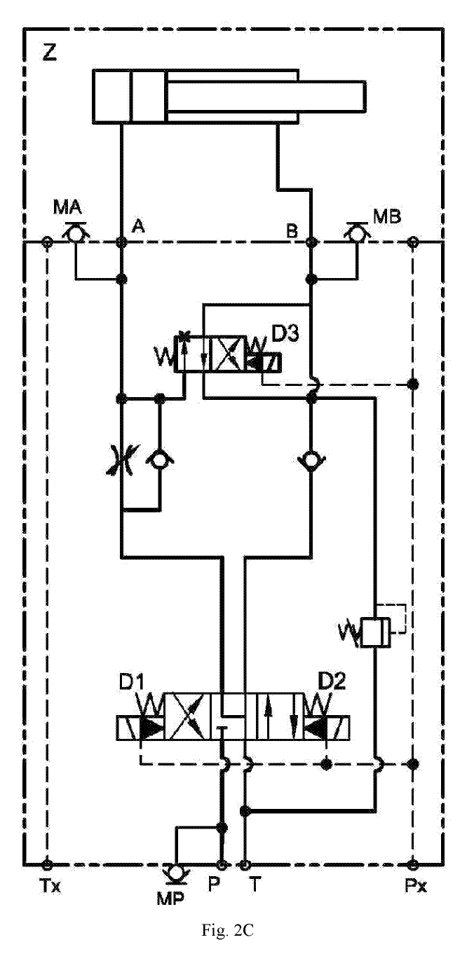

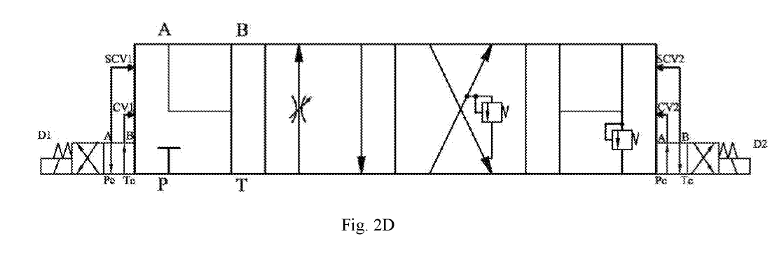

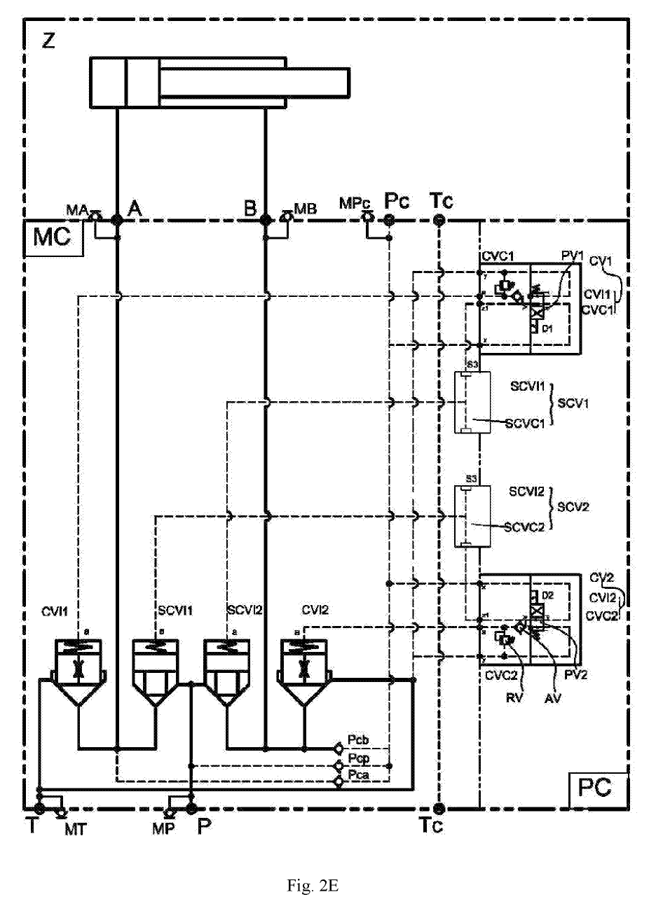

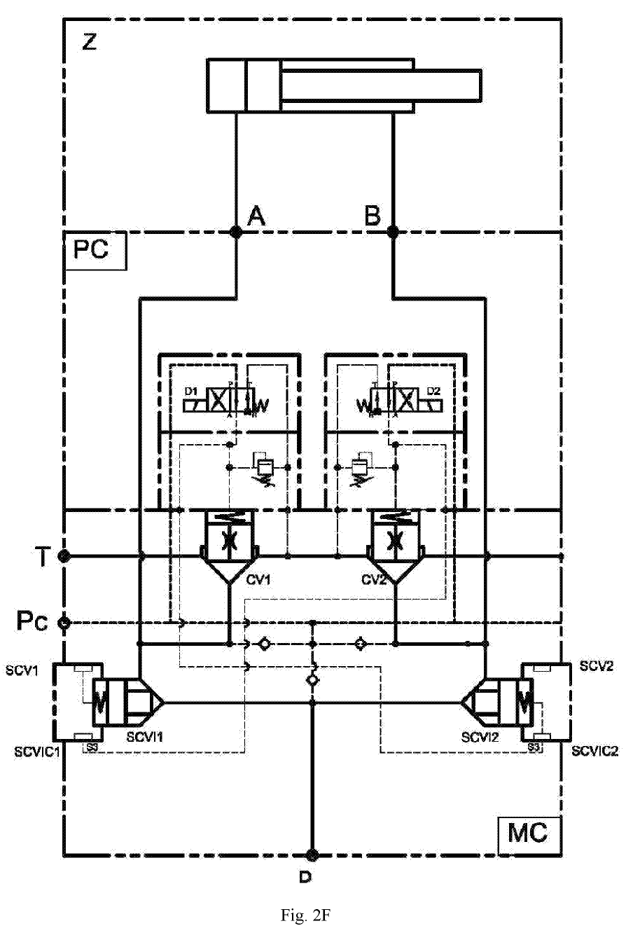

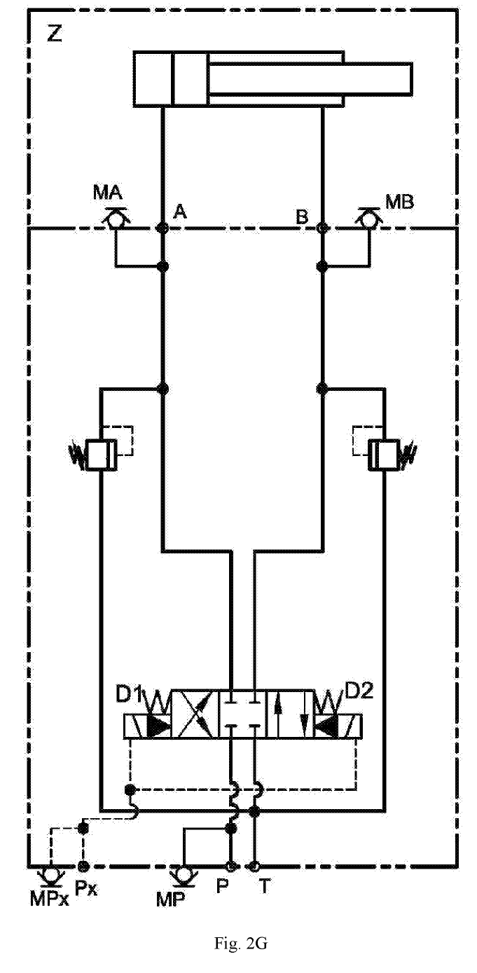

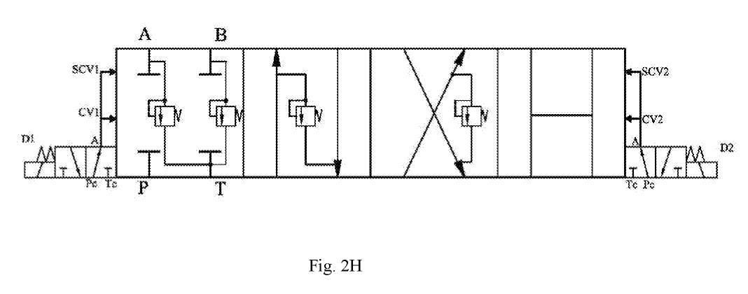

1. The new electro-hydraulic control terminal adopting a new kind of modularized and configured cartridge valve RHCV comprises two kinds of control resistance of different structures and combinational feature, which are compact two-way cartridge valves (MINISO CV, CV as abbreviation) and modularized and configured screw-in cartridge valves (MINISO SCV, SCV as abbreviation). The hybrid combination of two kinds of control resistance is used to control two reversible cavities (A, B) of controllable hydraulic actuators (Z representative of cylinder, M representative of motor). Two modularized and configured screw-in cartridge valves (SCV1, SCV2) are used as oil-input resistance, and two compact two-way cartridge valves (CV1, CV2) are used as oil-output resistance. They together with the integrated functional valve body characteristic of the four-way functional and connectional feature constitute the basic type electro-hydraulic control terminal. Integrated functional valve body has two forms BL and BH. Two compact two-way cartridge valves (CV1, CV2) are used as oil-output resistance arranged on the same side of the same face. And two modularized and configured screw-in cartridge valves (SCV1, SCV2) are used as oil-input resistance having different arrangements. They constitute two kinds of integrated functional valve body (BL, BH) with different internal mounting holes (CVH, SCVH) and layout of pilot control ports. In terms of BL valve body, two modularized and configured screw-in cartridge valves are arranged on the same side of the same face. In terms of BH valve body, two modularized and configured screw-in cartridge valves are arranged on the opposite side of the opposite face (see FIGS. 1A, 1B, 1C, 1D, 3A, 3B, 3C, 3D). Four main stages of poppet valve (CVI1, CVI2; SCVI1 SCVI2) are controlled by hybrid self-supplied pilot control network consisting of PV1 and PV2, which are pilot solenoid valve, check valve AV, combined plug PL on the combinational flange control cover plates CVC1, CVC2. Self-supplied oil Pc is imported by the control port X on the cover plate of compact two-way cartridge valve, pilot control oil is connected with oil-output port Tc through the control port Y, self-supplied oil Pc enters in the control cavity of main stage of poppet valve CVI1, CVI2 through control port a on the combinational flange control cover plates; through control port Z1 and Z2, control port S3 of modularized and configured screw-in cartridge valve SCV1, SCV2 arranged on the same side of the same face or on the opposite side of the opposite face is connected vertically. Thus four-way circuit technological scheme (see FIGS. 2A, 2C, 2D, 2E, 2F, 2G, 2H) based on regular layout of BL, BH is formed. According to different requirements of accessories for connection, detection and communication of BL, BH, independent and integrated electro-hydraulic control terminal LEM (FIGS. 1A, 1B) and HEM (FIGS. 1C, 1D) with different shapes and same supply chain characteristic with four controllable main ports P, T, A, B and multiple auxiliary ports are formed.

2. New principle scheme of circuit of electro-hydraulic control terminal adopting a new kind of modularized and configured cartridge valve RHCV consists of main stages CVI1,CVI2; SCVI1, SCVI2 of compact two-way cartridge valves CV1, CV2 and modularized and configured screw-in cartridge valves SCV1, SCV2 as loop of power level (MC in FIGS. 2A, 2B, 2C, 2D, 2E, 2F, 2G, 2H), pilot control components PV, SV, RV, AV, PL installed in or on the combinational flange control cover plates. The pilot control circuits (PC in FIGS. 2A, 2B, 2D, 2E, 2F, 2F, 2G, 2H) consists of pilot control elements and accessories installed in the screw adaptor SCVC1, SCVC2. The basic four-way resistance circuit with two kinds of hybrid resistance comprises power level circuit MC and pilot control circuit PC. The basic four-way resistance circuit is used to control two reversible controlled cavities A, B of double-acting hydraulic actuators Z, M. The connection and combination between power level circuit and pilot control circuit are modularized and decomposable combination. According to 4/4 circuit LEM and HEM of basic electro-hydraulic control terminal in claimed rights 1 and 2 and the setup of overall solution, the new principle scheme of circuit of independent and integrated electro-hydraulic control terminal with four controllable main ports P, T, A, B and multiple auxiliary ports Pc, Tc, Mc including accessories for connection, detection and communication is formed. The new principle scheme of circuit have two kinds of types available, one is complicated (see FIGS. 2A, 2E) and the other is simplified (see FIGS. 2B, 2F), The basic figure symbol of new principle scheme of circuit complies with related standard. The symbol of main stage of poppet valve is commonly shared by compact two-way cartridge valve and modularized and configured screw-in cartridge valve. But the screw adaptor of modularized and configured screw-in cartridge valve is newly composed. The new circuit schematic diagram shows internal hybrid mounting holes and pilot control ports of integrated functional valve body except different body types and external connection features. New circuit principle diagram is also listed with two schematic diagrams of “single component circuit” (see FIGS. 2C, 2G) and new position function symbols (2D, 2H) for comparison. Intelligent design and analysis by using the computer can be applied to the compact electro-hydraulic control terminal and the whole process of supply chain management.

3. In terms of integrated functional valve body BL, BH (see FIGS. 3A, 3B, 3C, 3D, 1A, 1B, 1C, 1D) of electro-hydraulic control terminal adopting a new kind of modularized and configured. cartridge valve, within the valve body (BL, BH) they have one arrangement that two mounting holes of compact two-way cartridge valves are on the same side of the same face (CVH1, CVH2), and two mounting holes of modularized and configured screw-in cartridge valves are arranged differently (SCVH1, SCVH2). According to the rules (new principle scheme of circuit of electro-hydraulic control terminal LEM, HEM, FIGS. 2A, 2B, 2C, 2D, 2E, 2F, 2G, 2H), in terms of BL valve body, two modularized and configured screw-in cartridge valves (SCVH1, SCVH2 are arranged on the same side of the same face (F1) adjacent to that of compact two-way cartridge valves (CVH1, CVH2). The BL internal mounting holes and pilot port layout feature can be referred to FIG. 3B. In terms of BH valve body, two modularized and configured screw-in cartridge valves (SCVH1, SCVH2) are arranged on the opposite side of the opposite face (F2, F4) adjacent to that of compact two-way cartridge valves (CVH1, CVH2). The BH internal mounting holes and pilot port layout feature can be referred to FIG. 3D. Self-supplied oil Pc is imported by the control port X on the mounting face (CVF1, CVF2, FIGS. 3A, 3B, 3C, 3D) of cover plate of compact two-way cartridge valve, pilot control oil is connected with oil-output port Tc through the control port Y, self-supplied oil Pc enters in the control cavity main stage of poppet valve CVI1, CVI2 through control port a on the combinational flange control cover plates; through control port Z1 and Z2, control port S3 of modularized and configured screw-in cartridge valve SCV1, SCV2 arranged on the same side of the same face or on the opposite side of the opposite face is connected vertically. According to different requirements of accessories for connection, detection and communication of BL, BH, integrated functional valve body of regular hexahedral shape characteristic with four controllable main ports P, T, A, B and multiple auxiliary ports are formed (FIGS. 3A, 3C).

4. The pilot control ports of integrated functional valve body BL, BH have the hybrid connecting feature of “one carrier controls more than one assembly”. It can be seen in the FIG. 4 (only connecting path between CV1 and SCV1 shown), self-supplied oil Pc after being compared and chosen within the valve body is imported by the control port X on the cover plate of compact two-way cartridge valve, pilot control oil is connected with oil-output port Tc through the control port Y, self-supplied oil Pc enters in the control cavity of main stage CVI1 of compact two-way cartridge valve through control port a on the combinational flange control cover plates; through control port Z1 and Z2, control port S3 of modularized and configured screw-in cartridge valve (only connecting path between CV1 and SCV1 shown) arranged on the same side of the same face or on the opposite side of the opposite face is connected vertically. The combined flange cover plates CVC1 (only CVCB, PIH, PVF shown) is used as main carrier of pilot control to realize “one carrier controls two assemblies” in terms of modularized and configured screw-in cartridge valve and compact two-way cartridge valve, which is an innovation to the traditional cartridge valves and plays an important role in the miniaturization of electro-hydraulic control terminal LEM and HEM.

5. The basic integrated functional valve body of new electro-hydraulic control terminal adopting a new kind of modularized and configured cartridge valve RHCV has two mounting holes of compact two-way cartridge valves and its pilot control ports, two mounting holes of modularized and configured screw-in cartridge valves and its pilot control ports. According to rules, symmetric layout of mounting hole of hybrid combination of four mounting holes for main stage can be is seen in the FIGS. 3A, 3B, 3C, 3D, and 1A, 1B, 1C, 1D. The new electro-hydraulic control terminal has the technological features of modularization, configuration, and open-design, and also customer-oriented personality feature. The integrated functional valve body adopts the margin design in layout of overall design and main structure. When the combination, function, specifications, quantity and local circuit scheme belonging to main stage of poppet valve and mounting holes of two cartridge valves change, even when the pilot control components and the corresponding pilot control ports change, it can make sure that existing margin of basic integrated functional valve body can be made use of. Personalization adaptability for a variant design can be remained by the prerequisite that layout of overall design and main structure are unchanged (see FIG. 5). When four mounting holes of basic: integrated functional valve body BL and BH with hexahedral shape are symmetric (FIGS. 1A, 1B, 1C, 1D and 3A, 3B, 3C, 3D), the margin design of mounting face with main functional structure and connection feature is adopted. There is a specialized design about the layout of F1-main functional mounting face of BL for the mounting holes of compact two-way cartridge valve and mounting face of combined flange cover plate, the layout of F5-main functional mounting face of BH. Besides, there is a specialized design about the layout of F5-main functional mounting face of BL for the mounting holes of modularized and configured screw-in cartridge valve, the layout of F2 and F3-main functional mounting face of BH. Because the above-mentioned mounting face not only influences the layout of main functional structure and connection feature, but also influences the margin design with different installation and connection features, it has a significant impact on the variant design. Other non-main functional structure and connection feature in the valve body with hexahedral shape influence the different installation and connection layout design, which can be seen in the FIGS. 15, 17 in 6A. Especially for many marks with 4-d in the attached figures, margin design for integrated functional valve body of basic BL and BH can be indicated through the setting of flange installation connecting face which can be directly or nearly connected with cylinders. Based on the symmetric layout of valve body BL and BH, variant design and local change can he implemented flexibly for the asymmetric layout. The overall layout and its shape design can be still maintained.

6. The basic integrated functional valve body is connected, fixed and sealed with the input and output of controllable actuator such as hydraulic cylinder throughout circumferential flange, combining into main body of electro-hydraulic control terminals and basic type of valve body which can be installed directly on the double-acting hydraulic actuator, port A or B of valve body installed directly separately matched with the port A or port B of hydraulic controllable actuator, thus directly connecting the main valve body with the corresponding ports of controllable actuator, the other port of basic valve body indirectly matched with the hydraulic actuator is connected with the hydraulic actuator through fittings and tubes, ports P and T of the basic valve body are connected with the oil supplier P and T through fittings and tubes.

7. The mounting face at the bottom of the basic integrated functional valve body has two ort more ports of P, A, B, T, the types of mounting face include one kind of mounting face conforming to Standard ISO4401 (see FIG. 7), the compact electro-hydraulic control terminals adopting Standard ISO4401 are alternatives of single hydraulic manifolds and sandwich integrated circuit bodies conforming to same Standard ISO4401 (see FIG. 17), the compact electro-hydraulic control terminals adopting Standard ISO4401 can also be installed on or near the input and output of controllable actuators such as hydraulic cylinders and motors (see FIG. 6C).

8. The basic integrated functional valve body group (see FIG. 8) consists of two valve bodies, valve body for installation at the bottom of valve body group uses the type of mounting face conforming to Standard ISO4401, and four main ports P ,A, B, T (see FIG. 8) are arranged on the tilting face of electro-hydraulic control terminals, the compact electro-hydraulic control terminals adopting Standard ISO4401 are alternatives of single hydraulic manifolds and sandwich integrated circuit bodies conforming to same Standard ISO4401 (see FIG. 17), the compact electro-hydraulic control terminals adopting Standard ISO4401 can also be installed on or near the input and output of controllable actuators such as hydraulic cylinders and motors.

9. The valve body (see FIG. 9) is connected and fixed with the controllable actuators including power units, hydraulic cylinders and motors, four main ports P, A, B, T set on the valve body are connected with the input and output ports of the controllable actuators including power units, hydraulic cylinders and motors through fittings and tubes directly, the screw holes (4-MH) are pre-set on the valve body for installation.

10. Among the hybrid combination of two sets of modularized and configured to screw-in cartridge valve and compact two-way cartridge valve, modularized and configured screw-in cartridge valve will be prioritized, after variant design regarding basic valve body ((see FIG. 10), other commercial screw-in cartridge valve conforming to Standard ISO7789 can be made use of. In FIG. 10, among the hybrid combination of two sets of modularized and configured screw-in cartridge valve and compact two-way cartridge valve, one screw-in cartridge valve is replaced by one compact two-way cartridge valve with displacement-mechanical feedback (SCVH1-PR), after variant design regarding basic valve body based on BH, it constitutes a kind of valve body with asymmetrical layout of mounting holes

11. In FIG. 11, among the hybrid combination of two sets of modularized and configured screw-in cartridge valve and compact two-way cartridge valve, one screw-in cartridge valve is replaced by one compact two-way cartridge valve with LVDT, after variant design regarding basic valve body, it constitutes a kind of valve body based on BL with asymmetrical layout of mounting holes, which consists of three mounting holes of compact two-way cartridge valve and a mounting hole of modularized and configured screw-in cartridge valve.

12. In FIG. 12, among the hybrid combination of two sets of modularized and configured screw-in cartridge valve and compact two-way cartridge valve, one screw-in cartridge valve having the function of pressure compensation SCV-LS is added, thus constituting the electro-hydraulic control terminals having the function of pressure compensation, one mounting hole SCV3-LS for the screw-in cartridge valve having the function of pressure compensation is added in the corresponding valve body, thus constituting a kind of valve body based on BL with asymmetrical layout of mounting holes, which consists of two mounting holes of compact two-way cartridge valve and three mounting holes of modularized and configured screw-in cartridge valve.

13. The electro-hydraulic control terminal that has the 3/4 loop function, consists of one compact two-way cartridge valve with 3 position pilot solenoid valve and three modularized and configured screw-in cartridge valves, integrated functional valve body is arranged with asymmetrical layout of mounting holes and consists of one mounting hole CVH1 of compact two-way cartridge valve and three mounting holes SCVH1, SCVH2, SCVH3) of modularized and configured screw-in cartridge valve (SCV1, SCV2, SCV3).

14. In FIG. 14, the basic type electro-hydraulic control terminal. Integrated functional valve body has two forms L and H. Two compact two-way cartridge valves (CV1 (M), CV2 (S)) are used as oil-output resistance arranged on the same side of the same face. And two modularized and configured screw-in cartridge valves (SCV1, SCV2) are used as oil-input resistance. Two compact two-way cartridge valves have different size to meet different needs of rod cavity and piston cavity of asymmetric double-acting cylinder with one rod. Two modularized and configured screw-in cartridge valves have same size. The electro-hydraulic control terminal characteristic of asymmetric layout of mounting holes has four controllable main ports P, A, B, T and multiple auxiliary ports. Integrated functional valve body based on BL consists of two mounting holes CVH1 (M) and CVH2 (S) of compact two-way cartridge valve characteristic of different sizes and two mounting holes (SCVH1 SCVH2) of modularized and configured screw-in cartridge valve.

15. Hybrid pilot control network con combined flange cover plates as main carrier, and screw adaptor. It complies with rules of decomposition combination and design, which is totally unique. The way “one carrier controls more than one assembly” is a distinguished character to differentiate combination technology of four-way circuit of cartridge valves. This way is mainly applied in the electro-hydraulic control terminal with self-supplied oil to control the double-acting cylinder. Self-supplied oil is replaced by external-supplied oil, thus constituting a kind of electro-hydraulic control terminal whose oil is supplied externally. It can be seen in FIG. 15. The integrated functional valve body BL and BH is a variant of the basic type valve body.

16. The four way circuit regarding technical solution of electro-hydraulic control terminal according to claim 1, wherein according to decomposition design and combination principle regarding the hydraulic circuit of two-way cartridge valve, it has decomposability; two cavities are controlled by one three-way hydraulic loop which consists of two cartridge valves with different structures and combination features and is a fundamental and independent solution to individual cavity of electro-hydraulic control terminals, electro-hydraulic control terminal conforming to three-way hydraulic loop is flexible to meet all kinds of functions and form structures, thus controlling the two cavities of double-acting controllable hydraulic actuator separately, electro-hydraulic control terminal conforming to three-way hydraulic loop can be used to control one cavity of single-acting controllable hydraulic actuator, constituting the electro-hydraulic control terminal to control single-acting controllable hydraulic actuator with one cavity. The basic type of integrated functional valve body can be seen in FIG. 6D.

17. Beneficial effects: the beneficial effects of the new electro-hydraulic terminal LEM and HEM adopting a new kind of modularized and configured cartridge valve RHCV can be further indicated in the FIG. 17. In the FIG. 17(a), IH is a kind of latest sandwich manifolds adopting traditional “single component loop”. It consists of the sandwich valves 4WEV, PLV, PAV, PRV and valve body BP. It is a hydraulic equipment with the function of complete 3/4 complicated circuit and the main ports P, A, B, T. In the FIGS. 17(a) and (b), 4WE belongs to the same 3/4 directional valve which is single component. What are described in FIG. (c)-(j) are some typical electro-hydraulic control terminal LEM and HEM. For the sake of comparison, entities have the same proportion. In terms of shape, volume and weight, electro-hydraulic control terminal (EM) indicated in FIG. (c)-(j) is the same with 4WE “single component”. Only slight differences exist, compared with FIG.(a), it is 1/2-1/3 of those of IH, EM terminal has complex function of 4/4, which can he seen in 2A, 2B, 2C, 2D, 2E, 2F, 2G, 2H. It is enough to replace IH with 3/4 function. By the contrast, power-to-weight ratio of LEM, HEM is only about 1/2-1/3 of IR, and has significantly compact, lightweight, miniaturized and flexible and diversified customized features, thus fundamentally subverting the traditional supply chain and the management pattern of “single component loop” manifolds. It has the advantage of high efficiency, low energy consumption and total cost is decreased.

A new enterprise competition strategy that is “functional diversities as many as possible can be achieved through technical diversities as few as possible” and market can be redefined.

What is described in the above shows and describes the basic principles and main characteristics of the present invention. These professional and technical is personnel should understand that this invention is not limited by the above-mentioned examples; the implementation of the case and what is manual only describe the principle of this invention. By the prerequisite that the spirit and scope of the invention are not breaking through, the invention also has all kinds of changes and improvements. These changes and improvements are under the rights to require the invention of the protection scope by the attached claim and its equivalent definition.

What we claim is:

1. The new electro-hydraulic control terminal adopting a new kind of modularized and configured cartridge valve RHCV, comprising:
two modularized and configured screw-in cartridge valves,
two compact two-way cartridge valves,
integrated functional valve body;
hybrid pilot control ports of self-supplied oil,
accessories for connection, detection and communication,
wherein two modularized and configured screw-in cartridge valves are used as oil-input resistance characteristic of different structures and combinational types in the basic four-way loop, within the valve body they have two different arrangements, one is that two screw-in cartridge valves are on the same side of the same face, the other is that two screw-in cartridge valves are on the opposite side of the opposite face;
wherein two compact two-way cartridge valves are used as oil-output resistance characteristic of different structures and combinational types in the basic four-way loop, within the valve body they have one arrangement that two two-way cartridge valves are on the same side of the same face, at least one compact two-way cartridge valve is necessary in the basic four-way loop;
wherein integrated functional valve body has two forms L and H according to different characteristics of internal mounting holes and layout of pilot control holes, form L is shaped when two modularized and configured screw-in cartridge valves are arranged on the same side of the same face, form H is shaped when two modularized and configured screw-in cartridge valves are arranged on the opposite side of the opposite face;
wherein hybrid pilot control ports of self-supplied oil are characteristic of that self-supplied oil Pc is imported by the control port X on the cover plate of compact two-way cartridge valve, pilot control oil is connected with oil-output port Tc through the control port Y, self-supplied oil Pc enters in the control cavity of compact two-way cartridge valve through control port a on the combinational flange control cover plates; through control port Z1 and Z2, control port S3 of modularized and configured screw-in cartridge valve is connected vertically, thus individually or combinational controlling the four main stage of poppet valve within the valve body;
wherein accessories for connection, detection and communication can be configured according to the demands of four-way loop;
wherein through the hybrid control resistances comprising modularized and configured screw-in cartridge valves and compact two-way cartridge valves, two reversible cavities of controllable actuators can he controlled, combining into independent and integrated electro-hydraulic control terminal LEM and HEM with different shapes, however, they have same supply chain characteristic with four controllable main ports P, T, A, B and multiple auxiliary ports.

2. The new electro-hydraulic control terminal adopting a new kind of modularized and configured cartridge valve RHCV according to claim 1,
wherein integrated functional valve body with L shape consists of two mounting holes of modularized and configured screw-in cartridge valves, two mounting holes of compact two-way cartridge valves, hybrid pilot. control ports of self-supplied oil, mounting holes and connection interface for connection, detection and communication, two mounting holes of modularized and configured screw-in cartridge valves are arranged on the same side of the same face, two mounting holes of compact two-way cartridge valves are arranged on the same side of the same face, at least one compact two-way cartridge valve is necessary in the basic four-way loop, accessories for connection, detection and communication can be configured according to the demands of four-way loop, two mounting holes of modularized and configured screw-in cartridge valves and two mounting holes of compact two-way cartridge valves are arranged on the adjacent face, they together with hybrid pilot control ports of self-supplied oil , mounting holes and connection interface for connection, detection and communication combine into integrated functional valve body BL characteristic of regular hexahedral shape with four controllable main ports P, T, A, B and multiple auxiliary ports.

3. The new electro-hydraulic control terminal adopting a new kind of modularized and configured cartridge valve RHCV according to claim 1,
wherein integrated functional valve body with H shape consists of two mounting holes of modularized and configured screw-in cartridge valves, two mounting holes of compact two-way cartridge valves, hybrid pilot control ports of self-supplied oil, mounting holes and connection interface for connection, detection and communication, two mounting holes of modularized and configured screw-in cartridge valves are arranged on the opposite side of the opposite face;
wherein two mounting holes of compact two-way cartridge valves are arranged on the same side of the same face, at least one compact two-way cartridge valve is necessary in the basic four-way loop, accessories for connection, detection and communication can be configured according to the demands of four-way loop, two mounting holes of modularized and configured screw-in cartridge valves and two mounting holes of compact two-way cartridge valves are arranged on the adjacent face, they together with hybrid pilot control ports of self-supplied oil, mounting holes and connection interface for connection, detection and communication combine into integrated functional valve body BH characteristic of regular hexahedral shape with four controllable main ports P, T, A, B and multiple auxiliary ports.

4. The new electro-hydraulic control terminal adopting a new kind of modularized and configured cartridge valve RHCV according to claim 1, wherein there are hybrid pilot control ports of self-supplied oil; self-supplied oil Pc after being compared and chosen within the valve body is imported by the control port X on the cover plate of compact two-way cartridge valve, pilot control oil is connected with oil-output port Tc through the control port Y, self-supplied oil Pc enters in the control cavity of compact two-way cartridge valve through control port a on the combinational flange control cover plates; through control port Z1 and Z2, control port S3 of modularized and configured screw-in cartridge valve arranged on the same side of the same face or on the opposite side of the opposite face is connected vertically, combinational flange control cover plates as the main carrier for pilot control comprehensively control compact two-way cartridge valves and modularized and configured screw-in cartridge valves, having the connecting feature of “one carrier controls more than one assembly”.

5. The new electro-hydraulic control terminal adopting a new kind, of modularized and configured cartridge valve RHCV according to claim 1 or claim 2 or claim 3, wherein the margin design is adopted in layout of overall design and main structure, including the first mounting face of main function, the second mounting face of main function, and mounting face of non-main function, the first mounting face of main function refers to the face with compact two-way cartridge valves' two mounting holes and the mounting faces of flange control cover plates, the second mounting face of main function refers to the face with two modularized and configured screw-in cartridge valves' mounting holes, mounting face of non-main function refers to the face for other non-main functional artifacts, when the combinations, functions, specifications, quantity, and local circuit scheme belonging to the main stage of poppet valve and mounting holes of two-way cartridge valves on the first mounting face of main function change, even when the pilot control components and the corresponding pilot control ports change, it can make sure that existing margin of basic integrated functional valve body can be made use of, the first and second mounting face of main function not only influence the layout of mounting face of main functional components and its connection features, but also influence the margin design of layout characteristic of different installation and connection; mounting face of non-main function influence the layout characteristic of different installation and connection.

6. The new electro-hydraulic control terminal adopting a new kind modularized and configured cartridge valve RHCV according to claim 1, wherein valve body is connected, fixed and sealed with the input and output of controllable actuator such as hydraulic cylinder throughout circumferential flange, combining into main body of electro-hydraulic control terminals and basic type of valve body which can be installed directly on the double-acting hydraulic actuator, port A or B of valve body installed directly is individually matched with the port A or port B of hydraulic controllable actuator, thus directly connecting the main valve body with the corresponding ports of controllable actuator, the other port of basic valve body indirectly matched with the hydraulic actuator is connected with the hydraulic actuator through fittings and tubes, ports P and T of the basic valve body are respectively connected with the oil supplier P and T through fittings and tubes.

7. The new electro-hydraulic control terminal adopting a new kind of modularized and configured cartridge valve RHCV according to claim 1, wherein the mounting face at the bottom of the valve body has two or more ports of P, A, B, T, the types of mounting face include e kind of mounting face conforming to Standard ISO4401, the compact electro-hydraulic control terminals adopting Standard ISO4401 are alternatives of single hydraulic manifolds and sandwich integrated circuit bodies conforming to same Standard ISO4401, the compact electro-hydraulic control terminals adopting Standard ISO4401 can also be installed on or near the input and output of controllable actuators such as hydraulic cylinders and motors.

8. The new electro-hydraulic control terminal adopting a new kind of modularized and configured cartridge valve RHCV according to claim 1, wherein valve body group consists of two valve bodies, valve body for installation at the bottom of valve body group uses the type of mounting face conforming to Standard ISO4401, and four main ports P, A, B, T are arranged on the mounting face of electro-hydraulic control terminals, the compact electro-hydraulic control terminals adopting Standard ISO4401 are alternatives of single hydraulic manifolds and sandwich integrated circuit bodies conforming to same Standard ISO4401, the compact electro-hydraulic control terminals adopting Standard ISO4401 can also be installed on or near the input and output of controllable actuators such as hydraulic cylinders and motors.

9. The new electro-hydraulic control terminal adopting a new kind of modularized and configured cartridge valve RHCV according to claim 1, wherein valve body is connected and fixed with the controllable actuators including power units, hydraulic cylinders and motors, four main ports P, A, B, T set on the valve body are completely connected with the input and output ports of the controllable actuators including power units, hydraulic cylinders and motors through fittings and tubes directly, the screw holes are pre-set on the valve body for installation.

10. The new electro-hydraulic control terminal adopting a new kind of modularized and configured cartridge valve RHCV according to claim 1, wherein among the hybrid combination of two sets of modularized and configured screw-in cartridge valve and compact two-way cartridge valve, modularized and configured screw-in cartridge valve will be prioritized, after variant design regarding basic valve body, other commercial screw-in cartridge valve conforming to Standard ISO7789 can he made use of, thus constituting a kind of valve body with asymmetrical layout of mounting holes, which consists of two mounting holes of compact two-way cartridge valve, a mounting hole of modularized and configured screw-in cartridge valve and a mounting hole of screw-in cartridge valve conforming to other types.

11. The new electro-hydraulic control terminal adopting a new kind of modularized and configured cartridge valve RHCV according to claim 1, wherein among the hybrid combination of two sets of modularized and configured screw-in cartridge valve and compact two-way cartridge valve, one screw-in cartridge valve is replaced by one compact two-way cartridge valve with LVDT displacement-electric feedback through which electro-hydraulic proportional flow adjustment can be realized, after variant design regarding basic valve body, it constitutes a kind of valve body with asymmetrical layout of mounting holes, which consists of three mounting holes of compact two-way cartridge valve and a mounting hole of modularized and configured screw-in cartridge valve.

12. The new electro-hydraulic control terminal adopting a new kind of modularized and configured cartridge valve RHCV according to claim 1, wherein among the hybrid combination of two sets of modularized and configured screw-in cartridge valve and compact two-way cartridge valve, one screw-in cartridge valve having the function of pressure compensation is added, thus constituting the electro-hydraulic control terminals having the function of pressure compensation, one mounting hole for the screw-in cartridge valve having the function of pressure compensation is added in the corresponding valve body, thus constituting a kind of valve body with asymmetrical layout of n mounting holes, which consists of two mounting holes of compact two-way cartridge valve and three mounting holes of modularized and configured screw-in cartridge valve.

13. The new electro-hydraulic control terminal adopting a new kind of modularized and configured cartridge valve RHCV according to claim 1, wherein the electro-hydraulic control terminal that has the 3/4 loop function, consists of one compact two-way cartridge valve with 3 position pilot solenoid valve and three modularized and configured screw-in cartridge valves, integrated functional valve body is arranged with asymmetrical layout of mounting holes and consists of one mounting hole of compact two-way cartridge valve and three mounting holes of modularized and configured screw-in cartridge valve.

14. The hybrid layout of pilot control ports of new electro-hydraulic control terminal's main valve body according to claim 1, wherein self-supplied oil is replaced by external-supplied oil, thus constituting a kind of electro-hydraulic control terminal whose oil is supplied externally.

15. The four way circuit regarding technical solution of electro-hydraulic control terminal according to claim 1, wherein according to decomposition design and combination principle regarding the hydraulic circuit two-way cartridge valve, it has decomposability; two cavities are controlled by one three-way hydraulic loop which consists of two cartridges with different structures and combination features and is a fundamental and independent solution to individual cavity of electro-hydraulic control terminals, electro-hydraulic control terminal conforming to three-way hydraulic loop is flexible to meet all kinds of functions and form structures, thus controlling the two cavities of double-acting controllable hydraulic actuator separately, electro-hydraulic control terminal conforming to three-way hydraulic loop can be used to control one cavity of single-acting controllable hydraulic actuator, constituting the electro-hydraulic control terminal to control single-acting controllable hydraulic actuator with one cavity, the basic type of integrated functional valve body conforming to three-way hydraulic loop consists of one mounting hole of compact two-way cartridge valve and one mounting hole of modularized and configured screw-in cartridge valve, this kind of hybrid combination solution including electro-hydraulic control terminal with externally supplied pilot oil has the feature of variant adaptability.

16. The new electro-hydraulic control terminal adopting a new kind of modularized and configured cartridge valve RHCV, comprising:
two modularized. and configured screw-in cartridge valves,
two compact two-way cartridge valves,
integrated functional valve body;
hybrid pilot control ports of self-supplied oil,
accessories for connection, detection and communication,
wherein two modularized and configured screw-in cartridge valves have same size, two compact two-way cartridge valves have different size to meet different needs of rod cavity and piston cavity of asymmetric double-acting cylinder with one rod;
wherein integrated functional valve body has asymmetric layout of mounting holes;
wherein the electro-hydraulic: control terminal characteristic of mechanical-electro integrated connection for installation and supply chain has four controllable main ports P, A, B, T and multiple auxiliary ports.
